(19) United States
(12) Patent Application Publication
(10) Pub. No.: US 2009/0024423 A1
(43) Pub. Date: Jan. 22, 2009

(54) System and Method for Automated Vehicle Tracking

(76) Inventors: John Hay, Earlysville, VA (US); Kenneth Brown, Charlottesville, VA (US)

Correspondence Address: WOODS, ROGERS, P.L.C., 1505 LONDON ROAD, CHARLOTTESVILLE, VA, 22902-8681, US

(21) Appl. No.: 12/175,937

(22) Filed: Jul. 18, 2008

Related U.S. Application Data
(60) Provisional application No. 60/950,886, filed on Jul. 20, 2007.

(51) Int. Cl. G06Q 10/00; G06Q 50/00

(52) U.S. Cl. 705/5

(57) ABSTRACT

A system and method for enhancing revenue of vehicle dealerships by increasing both the number of service appointments made by customers at the dealership as well as the number of those appointments which are kept by customers. A computer automated, Internet-based method is provided for supervising the appointment making and the service providing process at vehicle service locations. Service department activity at multiple service locations maintained by a single dealership or by multiple dealerships can be monitored so that material and labor resources can be efficiently allocated and managed between the multiple locations.

### CROSS REFERENCE

This application claims the benefit of U.S. Provisional patent application No. 60/950886, filed Jul. 20, 2007, which is incorporated herein by reference in its entirety.

### TECHNICAL FIELD

The subject invention relates generally to a system and method for assisting vehicle service departments in tracking the status of specified vehicles which are either in the process of being serviced or which need to be serviced in the future. More particularly, this invention enables service departments to improve efficiency and properly allocate resources such as manpower and inventory.

### BACKGROUND OF THE INVENTION

Both vehicle sales and service businesses take many measures to obtain return business from their customers. Customer loyalty and retention not only ensures an ongoing revenue stream from repairs and maintenance work but also increases the likelihood of repeat vehicle purchases in the future from those same customers. One such measure which is effective is to develop a link between the customer's vehicle service needs and the vehicle dealer's service department. Various attempts have been made to develop such links. For example, computer-driven prompting systems for vehicular maintenance using a database for providing prompts for setting up service appointments and for tracking what maintenance should be performed at future service appointments are disclosed in the patent to Chapin, Jr. (U.S. Pat. No. 5,931,878). Providing maintenance based on monitoring maintenance data for a particular vehicles and modifying scheduled maintenance based on the severity of use of each vehicle is further disclosed in the patent to Morronigiello et al (U.S. Pat. No. 6,901,318). The patent to Dan et al (U.S. Pat. No. 6,948,171) discloses a method for adaptive scheduling vehicle maintenance based on predictions of future events based on historical information related to a specific vehicle.

However, the appointment systems known in the art all have one or more failings ranging from excessive delays in handling incoming service telephone calls or the routing of such calls to the use of potentially annoying voicemail systems. Such systems are typically unable to forecast day to day shop capacity out into the distant future. Usually, the appointment system relies solely on dispatching systems where every technician is assumed to accurately punch on and off every job, no technician turnover is presumed to occur and those responsible for making future appointments adjust for manpower availability in the future. Failure to account for vacation and training of technicians can further complicate capacity forecasts. Similarly, most appointment systems cannot track the mix of work being performed and scheduled without doing so manually and without running multiple reports. Appointment systems are generally unable to forecast next appointments based on driving habits or to track customers who have no next appointment based on their driving habits. In addition, appointment systems have no facility for managing customers who are waiting for service to be performed on their cars so that intermittent inquiries from such customers lead to work flow interruption. Also, spotty coordination of shuttle seat availability on transportation made available to customers who want to leave and come back later to pick up their vehicles often results when known appointment systems are employed. Existing systems similarly experience difficulty in or simply omit tracking of loaner vehicles, vehicle pick-ups completed and vehicles delivered.

Other dealer-specific problems also remain unresolved. Many service shops are divided into teams, and known appointment systems cannot forecast shop loading by team leading to uneven team scheduling. Need-to-know information should be made available to users of an appointment system on a single computer screen but is not. Prediction of future business would facilitate efficient resource management such as the use of “just-in-time” advertising. Real time information across an entire group comprised of multiple service teams and/or multiple service locations should be available to enable cross leveling incoming appointment calls across a business development center (BDC). The dealership should also be able to manage its part-time and work-at-home workforce. Still further difficulties involve unpredictable backlogs of work, missed promise times to customers, a poor mix of work, inaccurate schedules of what materials and services customers are owed, inadequate tracking of vacation and training causing surprise capacity issues, improper or absent timing of selling or up-selling efforts directed to customers, undesirably high “no show” rates of customers for scheduled maintenance work, running out of work, inability to offer accurate and credible next appointments to customers, undeliverable special order parts (SOPs), poorly timed advertising campaigns and poor customer satisfaction. Present appointment systems simply do not provide solutions in all of these areas.

Another aspect absent from most appointment systems is that they cannot provide real-time access to all personnel in a multi-location dealership. This same failing hampers management from obtaining a consolidated picture of present and future operations and keeps appointment personnel from cross assisting between dealerships in a multi-location situation. An Internet-based appointment systems would solve these latter problems and, in addition, enable efficient utilization of part-time, at-home workers and remote call centers. Other improvements to known appointment systems could simultaneously address the other problems described above.

### SUMMARY OF THE INVENTION

This invention relates to a computer automated, Internet-based system and method for tracking and increasing the volume of vehicle service appointments made and kept at one or more service locations run by one or more vehicle dealerships. Each service location for each dealership has at least one terminal station or computer which is connected to any other service locations of that dealership server, to a local server for that dealership and to the Internet over a local area network (LAN). Each dealership is further connected over the Internet to a remote server having access to a storage device for storing multiple databases used in the execution of the method of this invention. The method involves retrieving an appointment grid from the remote server and displaying that appointment grid at one or more service locations to an authorized user, editing labels in the appointment grid if desired and selecting a function or process to be performed from the group consisting of configure, select date, calculate date, send reminder and generate reports. Once a function is selected, it is performed and data appearing in the appointment grid is continuously updated and displayed as data is entered while performing the function. An advantage of the system and method of this invention is that for any given vehicle service appointment the method mandates calculation and scheduling of a next appointment date for that vehicle and establishes and executes a reminder schedule to encourage customers to keep those appointments. As a result, customer retention and dealership revenue are improved and resources at each service location are more efficiently allocated.

### BRIEF DESCRIPTION OF THE DRAWINGS

The foregoing and other objects, aspects and advantages of the invention will be better understood from the following detailed description of the invention with reference to the drawings, in which

FIG. 1 is a flowchart providing a general overview of the method of the present invention.

FIG. 2 is block diagram of the hardware and communications arrangements for carrying out the data processing and operational methodology of the present invention.

FIG. 3 is a flowchart providing details of the configuring the appointment grid process.

FIG. 4 is a flowchart providing details of the calculating an appointment date process.

FIG. 5 is a flowchart providing details of the establishing a reminder date process.

FIG. 6 is a flowchart providing details of the generating reports process.

FIG. 7 is a screen shot of the Appointment Grid of the method of this invention.

FIG. 8 is a flowchart providing details of how an instance of customer service is handled.

### DESCRIPTION OF THE PREFERRED EMBODIMENT OF THE INVENTION

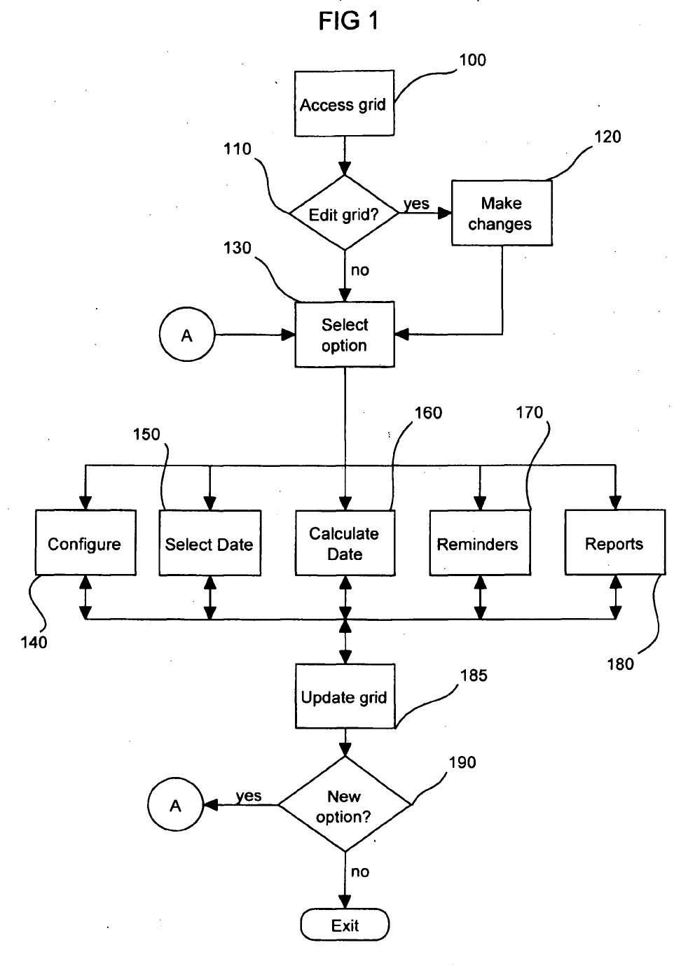

The method of this invention uses data input either by personnel from one or more locations of a vehicle dealership or via data integration with the dealership's dealer management system (DMS) to establish and track vehicle service appointments as well as to provide other services and perform managerial and administrative functions. FIG. 1 displays a simplified overview of this method in which data identifying known locations and/or dealerships desiring to cooperatively use the system has been entered and stored on a remote server. At 100, an authorized user accesses the Internet in order to link through a website URL portal to the system and method of this invention. At this URL, the user is presented with a display of the invention's Appointment Grid (discussed below) after successfully navigating a secure login process. The specific data appearing in the Appointment Grid depends on the authorization status of the user and can be limited to data for a specific vehicle or expanded to included data for multiple locations or multiple dealerships. If the user desires to edit labels appearing on the grid, as determined at 110, such changes are made at 120. The user then selects an optional function or process to perform at 130 from those displayed on the Appointment Grid. The available functions are configuring the appointment grid 140, selecting a calendar date 150, calculating an appointment date 160, establishing a reminder date 170 and producing reports 180. The Appointment Grid is continuously updated and displayed at 185 to reflect entry of interrelated data resulting from full or partial performance of one of the functions. Either during or after completing a function, if the user wants to perform a further function, as determined at 190, the process returns to select option 130. Otherwise, the method may be exited. Note that the user may navigate or toggle back and forth between functions without having completed already initiated functions and without losing data from those already initiated functions.

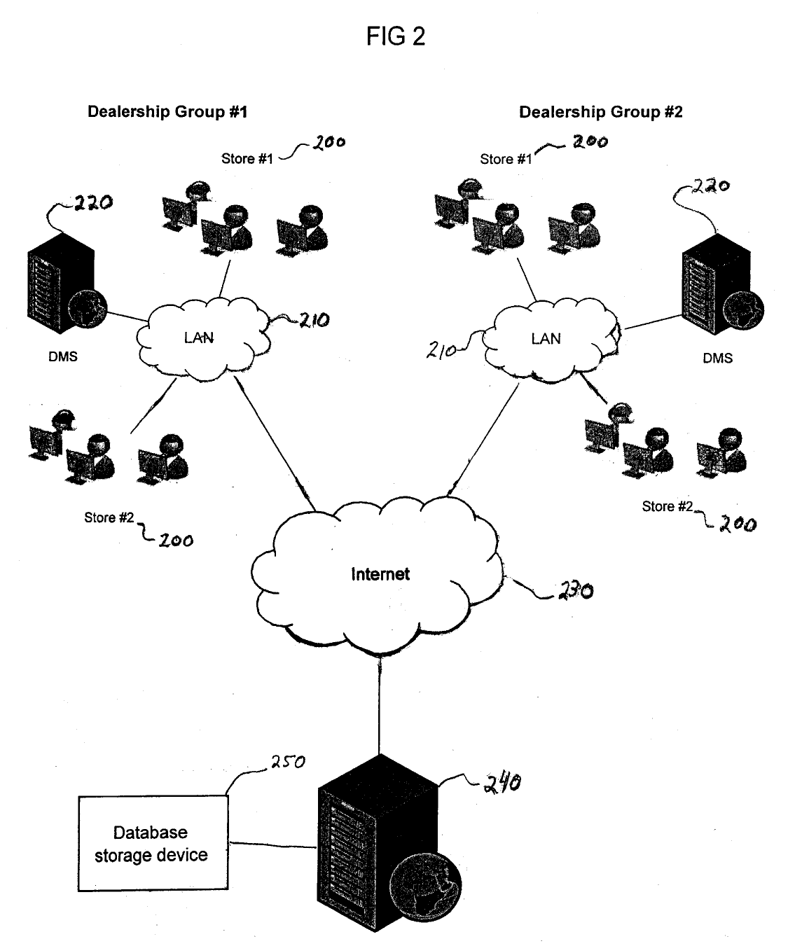

The system and method of this invention can be used by a single automobile dealership having but a single location but it is most advantageously used by either a single dealership having multiple locations or multiple cooperating dealerships each having one or more operating locations. Where multiple locations are involved, the system of this invention requires that each dealership have access to the Internet, for example with a broadband or other high speed type of telecommunications connection. Each of the separate locations communicate over the Internet with a remote central server where data is received, processed as described below and stored in various files, as needed. FIG. 2 depicts an example of the hardware and system needed for this system and further shows the computing equipment required at each remote location.

In order to practice the method of this invention at, for example, two different groups of dealerships, users at stores 200 comprising each dealership group could be connected by local area network (LAN) 210 at each remote location to each other, to server 220 running the dealer management system and to Internet 230. The computer systems used by users at stores 200 include at least one display device and a modern IBM compatible or Macintosh computer with a modem Web Browser connected to Internet 230. Remote server 240, houses the service appointment application of this invention and includes a modern Web server with database functionality. Remote server 240, incorporates or is connected to at least one database storage device 250 for storing and accessing various databases used by the system including the customer history database as well as other databases discussed below. The customer history database incorporates for each vehicle the delivery date of that vehicle to a customer, the name, address and telephone and email contact information of the customer who owns the vehicle, the delivery date, the mileage of the vehicle on the delivery date, the current date, the mileage of the vehicle on its last service date, whether appointment is for standard maintenance, maintenance schedule intervals in miles for vehicle makes, models and years for each model serviced by a participating dealership, the miles per day (MPD) driven by that customer in that vehicle. In addition, the remote server periodically calculates and stores an average MPD based on the experience of all serviced at a particular location. At each location using this system, an in-house computer system having at least one CPU, a display device, a storage device and a printer is required. Each such in-house computer creates a periodic audit-type report entitled Active Delivery Proof to track if employees are making follow-up appointments as enabled by the system and method of this invention.

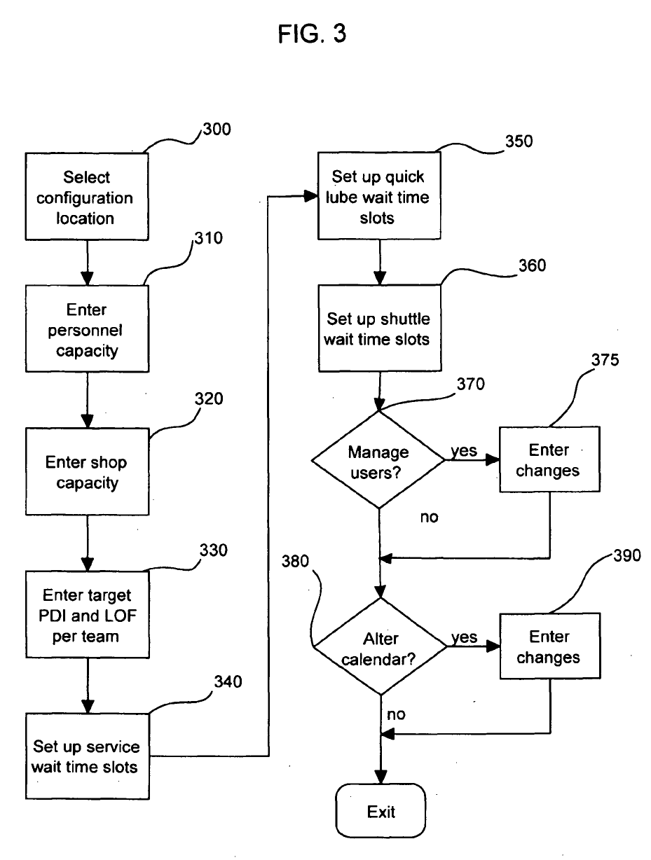

FIG. 3 is a flowchart showing details of configure process 140 of FIG. 1 which is accessible initially, periodically and on an ongoing basis. An advantage of an Internet-based appointment system is that it can be configured easily and securely for one or multiple locations through online access to a single remote server. During configuration, data, parameters and values are input, the use and interaction of which are important in achieving the various advantages of this invention. Thus, at 300 the authorized selects a location to be configured from among a list of such locations stored in a location identification database. The location can be a 1S single location, one of a number of locations for a single dealership or a location selected from those of multiple dealerships cooperatively using the appointment system. Existing data for that or those locations is then retrieved from remote server 240. If no data for one or more locations exists, the user then enters default data and values for such locations. At 310, personnel related potential capacity of the location is entered. It has been found advantageous and efficient to organize maintenance personnel into multiple groups or teams. The teams are separately identified, and the names and the number of technicians assigned to each team are entered. The teams typically include general maintenance teams which could, for example, be identified by color names (i.e., blue red, green and gold). In addition, the maximum potential number of potential quick lubrication and oil change jobs which can be performed and of available shuttle bus seats for the selected location are also entered. All of this data is stored in a personnel potential capacity database. At 320, the shop maintenance service capacity of the location is entered. This capacity may be expressed as either flat rate hours (FRH) per job or repair orders (RO) per day. Capacity may be further broken down into ranges such as, for example, “Under 2” and “Over 2”. The “Under 2” category refers to vehicles less than two years old costs related to which are still likely covered by a manufacturer's or other warranty, while the “Over 2” category refers to vehicles more than two years old for service on which the customer must likely pay. All of this data is stored in a shop potential capacity database. A further capacity assignment is made at 330 covering the number of vehicle pre-delivery inspections (PDI) and the percentage of lubrication and oil changes (Lube-Oil-Filter or LOF) allocated to each team. LOF is expressed as a percentage to show the amount of appointment capacity which has been used. Again, this data is stored in the shop potential capacity database. As assignments for particular jobs are made, these are stored in a shop assignment database. Note that the appointment grid displays both the potential capacities for a selected location and date under the heading Capacity and the actual capacities on a particular date at that location in each of the categories just described under the heading Situation so as to reflect the assignment and utilization of resources as a control mechanism. Thus, the entries under Situation reflect for each category of cell the potential capacity less the assignments made for each such category. Next, time slot allocations for each type of service occurs by adding or deleting specific time periods, typically at one-half hour intervals, although the intervals can be varied. Thus, service wait time slots for customers who desire to wait for general maintenance on their vehicles to be completed are selected and entered at 340. Quick lubrication wait time slots for those customers who desire to await completion of lubrications and oils changes are selected and entered at 350. Shuttle bus time slots indicating times at which shuttle bus transportation for customers who do not wish to wait for completion of service are selected and entered at 360. This data is stored in the time slot database. If the authorized users of the system need to be modified by additions or deletions, as determined at 370, such entries are made at 375 where the edited user's role, i.e. Manager, Supervisor, etc., may also be indicated and such changes are then saved in the memory of the remote server in the authorized user database. As with capacities, the appointment grid also displays for any given date both the number of customers who are waiting for their vehicles and, if desired, the number of customers who are not waiting. Periodically, the calendar used by the system to schedule appointments may need to be adjusted to account for holidays and/or particular closing dates. If such changes are desired, as determined at 380, the appropriate entries are made at 390. Such changes to the calendar are stored in the calendar database in database storage device 250 at remote server 240. Finally, the Appointment Grid is updated and harmonized throughout for any entries or changes made during the configuration process and the process is exited.

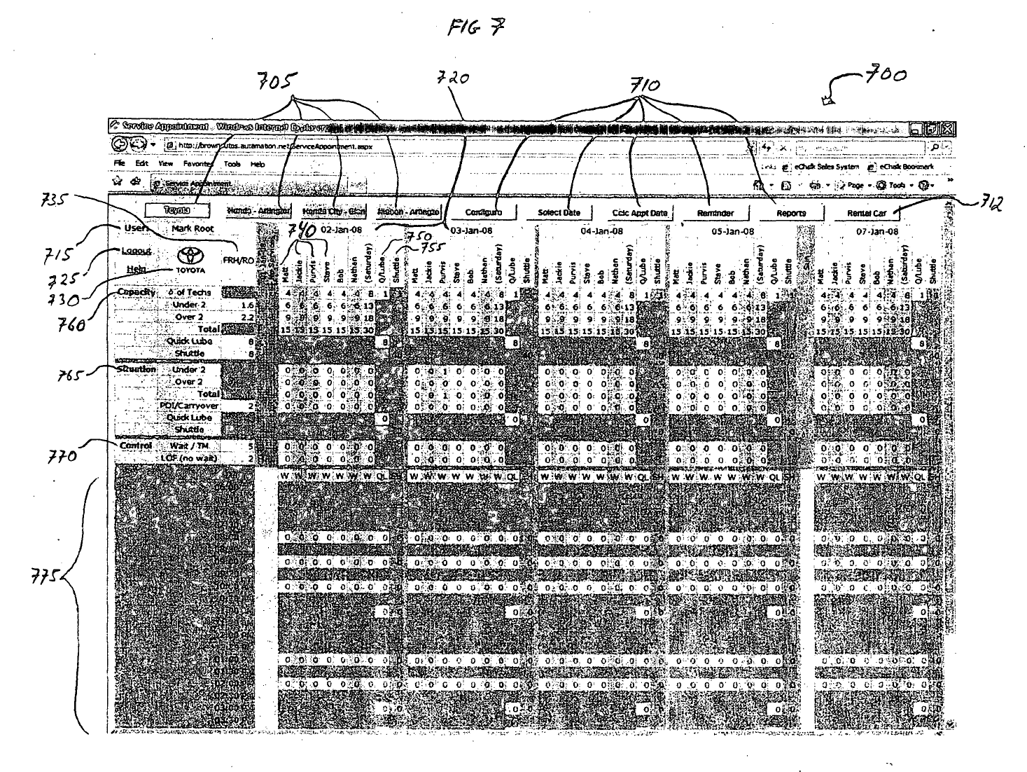

Select date process 150 provides a way for a user to view the appointment grid for any desirable date or configurable group of dates. For example, five dates may be displayed online in a horizontal group of adjacent cells in the Appointment Grid immediately below the line displaying option choices. As a default, the current calendar date appears as the leftmost cell in the horizontal group of date cells followed by the number of consecutive dates, if any, which the user has selected to view. The entire appointment grid is automatically populated with data for all of the displayed dates which is retrieved from the remote server. If the user selects a different date to view from a drop down calendar which appears after clicking on the tab for select date process 150, that date will be substituted for the current date in the leftmost cell along with the number of consecutive following dates previously selected. Vertical columns of cells associated with each date cell display data relating to potential (designated “Capacity” in FIG. 7) and actual (designated “Situation” and “Control” in FIG. 7) capacities associated with that date. The actual capacities are continuously updated depending on events and entries by users as described below.

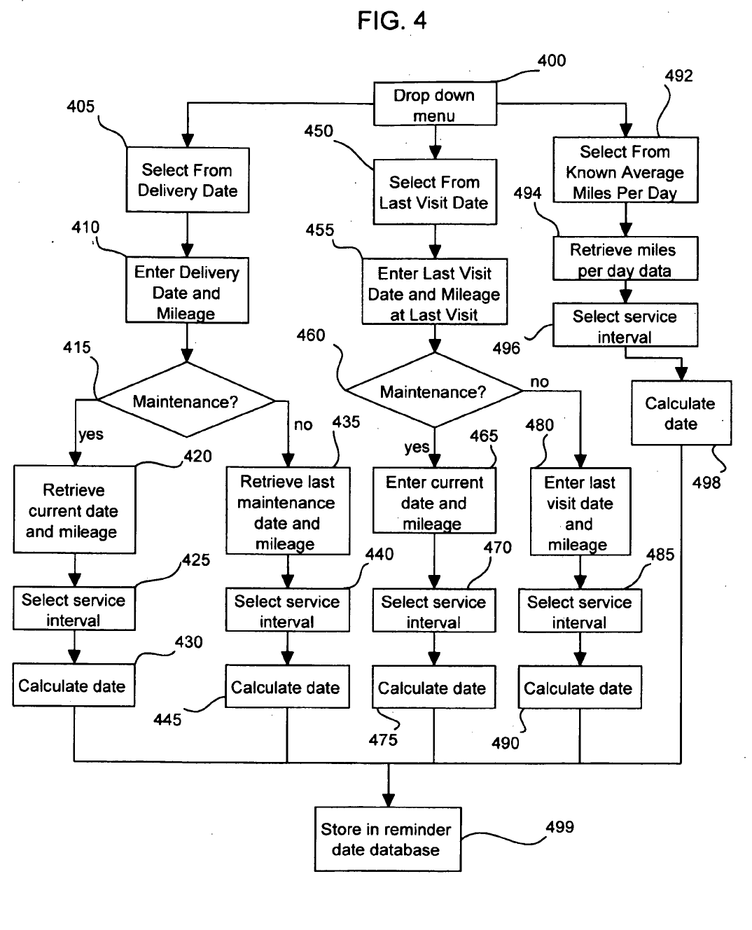

FIG. 4 is a flowchart illustrating the calculating an appointment date process 160 which lets the system user forecast and set a next appointment date for a known vehicle based on input criteria. It should be noted that the calculate appointment date process can be entered either by manual selection but that it is also entered automatically whenever an invoice for a completed job is generated. It is automatic entry into this process that forces personnel at locations using this method to schedule next appointments with customers before the customers leave the premises thereby increasing customer retention, the number of appointments made and kept and revenue from performing vehicle service. This process is applicable both to new vehicles being initially delivered to an owner and to vehicles already driven by the owner. A drop-down menu is displayed at 400 whenever the calculate appointment date function is called, whether automatically, such as when an invoice is issued, or manually. This menu provides three choices governing how the date is calculated. If the “From Delivery Date” option is chosen at 405, the vehicle delivery date and delivery mileage are entered at 410. If the vehicle is currently at the service location for standard maintenance, as decided at 415, the present date is designated the current date and the vehicle's current mileage are entered at 420. Current Mileage defaults to “0” to anticipate delivery of new vehicles. A next service mileage interval (NSM), such as 3500, 5000, 7500, 10000 or 12000, is selected at 425. A next appointment date is calculated at 430, first, by dividing the total miles driven, as indicated by the difference between the current mileage and the delivery mileage, by the number of days driven, as indicated by the number of days which have passed between the delivery date and the current date, to obtain the miles driven per day (MPD). Then, the NSM is divided by the MPD to determine the number of days from the current date until the desired next appointment. An actual appointment date is selected by referring to a calendar to pick an appropriate future date which does not fall on a holiday or other non-business day. If the vehicle is not at the service location for standard maintenance, the last maintenance date and odometer mileage on the last maintenance are retrieved from the customer history database at 435. A next service mileage interval (NSM), such as 3500, 5000, 7500, 10000 or 12000, is selected at 440. A next appointment date is calculated at 445, first, by dividing the total miles driven since the last maintenance date, as indicated by the difference between the current odometer mileage reading and the mileage on the last maintenance date, by the number of days which have passed from the last maintenance date to the current date to obtain the miles driven per day (MPD). Then, the NSM is divided by the MPD to determine the number of days from the last maintenance service date until the suggested next appointment. An actual appointment date is selected by referring to a calendar to pick an appropriate future date which does not fall on a holiday or other non-business day. If the “From Last Visit Date” option is chosen at 450, the date of the last visit to the service location and the mileage at that last visit are entered at 455. If the current visit is for standard maintenance, as determined at 460, the current mileage of the vehicle and the current date are entered at 465. A next service mileage interval (NSM), such as 3500, 5000, 7500, 10000 or 12000, is selected at 470. A next appointment date is then calculated at 475, first, by dividing the total miles driven, as indicated by the difference between the current mileage and the mileage at the last maintenance visit to the service location, by the number of days driven, as indicated by the number of days which have passed between the last visit date to the service location and the current date to obtain the miles driven per day (MPD). Then, the NSM is divided by the MPD to determine the number of days from the current date until the desired next appointment. An actual appointment date is selected by referring to a calendar to pick an appropriate future date which does not fall on a holiday or other non-business day. If the vehicle is not at the service location for standard maintenance, the last visit date and mileage at the last visit are entered at 480. A next service mileage interval (NSM), such as 3500, 5000, 7500, 10000 or 12000, is selected at 485. A next appointment date is then calculated at 490, first, by dividing the miles driven since the last visit to the service location, as indicated by the difference between current mileage and the mileage at the last visit to the service location, by the number of days driven, as indicated by the number of days which have passed between the last date and the current date to obtain the miles driven per day (MPD). Then, the NSM is divided by the MPD do determine the number of days from the last maintenance operation was performed until the desired next appointment. An actual appointment date is selected by referring to a calendar to pick an appropriate future date which does not fall on a holiday or other non-business day. If the “From Known Average Miles Per Day” option is selected at 492, data is retrieved from the customer history database at 494 based on prior experience with a vehicle owner indicating what average number of miles per day (MPD) that owner typically drives. Alternatively, a miles per day figure can be retrieved from the average miles per day database which represents an estimate based on the experience of the dealership with customers in its geographic area. Next, a next service mileage interval (NSM), such as 3500, 5000, 7500, 10000 or 12000, is selected at 496. Then, a next appointment date is calculated at 498, first, by dividing the service interval selected at 496 by the MPD figure retrieved at 494 to obtain the number of days from the current date until the proposed next appointment date. An actual appointment date is selected by referring to a calendar to pick an appropriate future date which does not fall on a holiday or other non-business day. Regardless which method is used to calculate a next appointment date, the eventually selected date is stored in the reminder date database together with vehicle and owner identification information at 499 for use, as needed, at a future date.

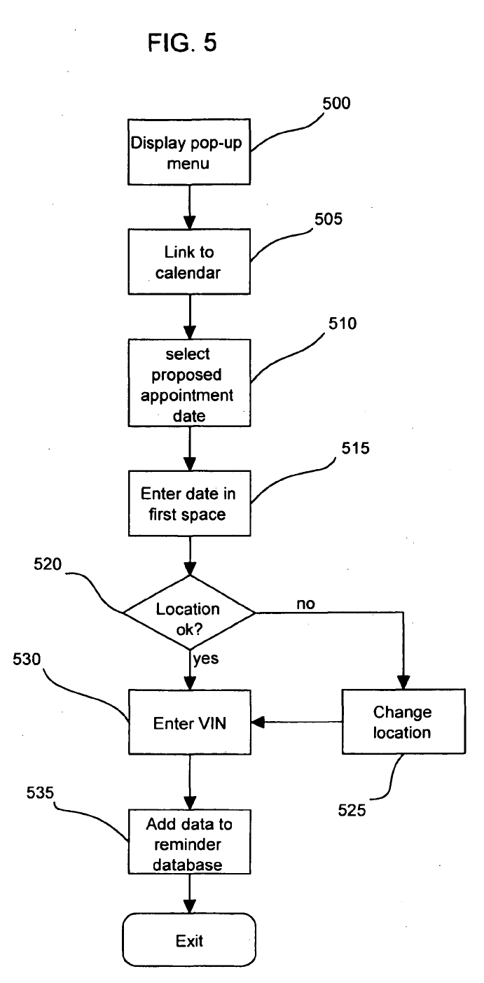

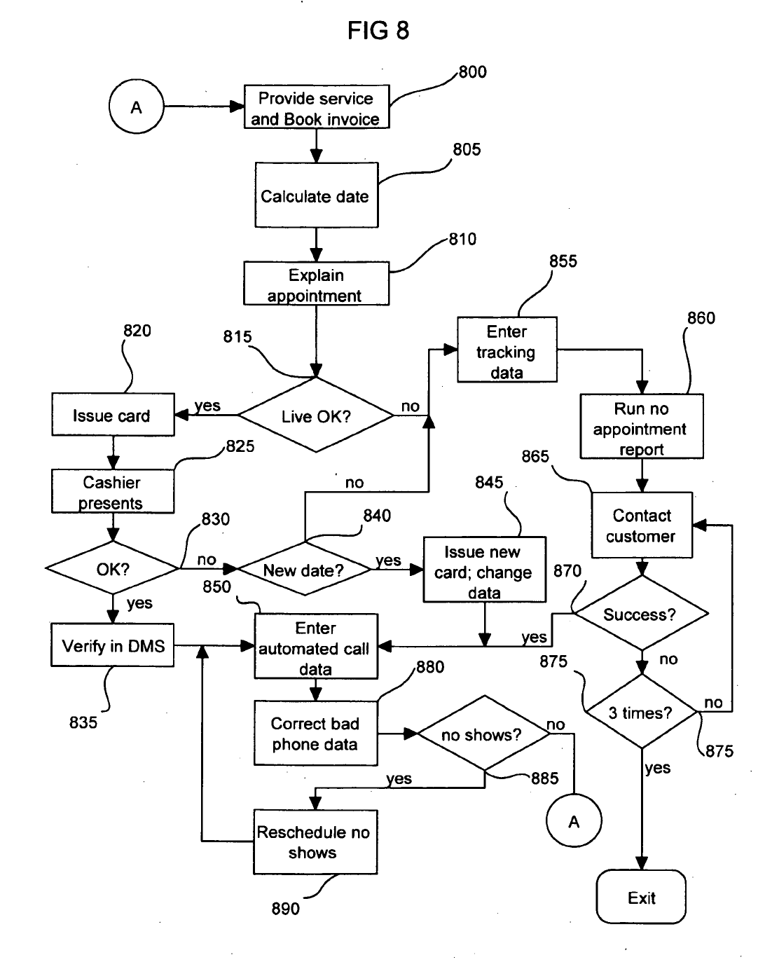

If a customer declines the proposed appointment date displayed at 435, the system user can select appointment reminder date process 170, a flowchart showing the process of which is provided in FIG. 5. Initiating this process causes a pop-up menu to be displayed at 500 which includes three spaces for entry of the scheduled appointment date, the service center location and the vehicle identification number (VIN) of which only an abbreviated version, such as the last six digits, need be entered. Once a vehicle is integrated into the system, the VIN number can be pulled from the DMS. By clicking on a displayed button linked to the scheduled appointment date first space at 505, a modifiable calendar is displayed through which the user may select the proposed appointment date at 510 which was rejected by the customer. This date is then entered automatically into a first space at 515. The second space for the service center defaults to the dealership location of the user. A decision must be made at 520 whether that is the location desired for servicing this vehicle. If not, the location is changed at 525. If so, the user enters an abbreviated version of the VIN into the third space at 530. Finally, the user selects a schedule reminder link at 535 to modify the reminder date database stored at the remote server to include data relating to the present vehicle. As explained in greater detail with regard to FIG. 8, if a customer declines a next appointment date, the reminder function is used to save a putative appointment date along with the VIN number of the vehicle and the home telephone number of the customer. At the beginning of each month or on any other preferred schedule, a reminder report is created to display or print out a list of customers with due dates in the current month who do not have appointments. An email reminder with a proposed service date typically based on calculations related to mileage driven by that customer is sent to the customer. Thereafter, an automated or manual reminder telephone call is placed to the customer in the absence of any contact initiated by the customer to confirm the proposed appointment.

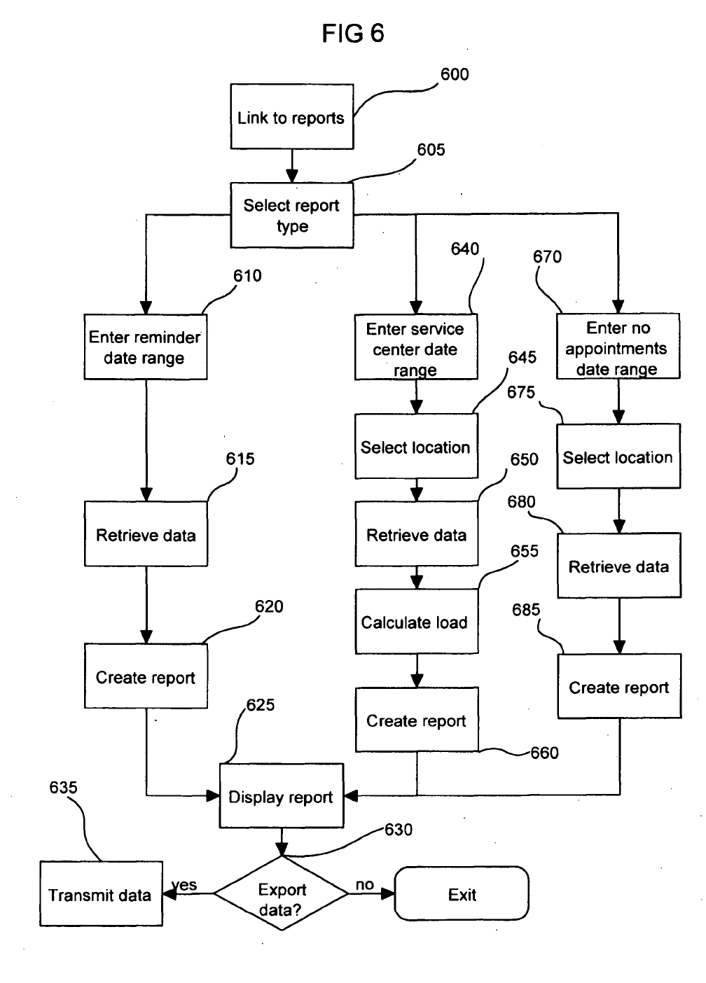

The appointment grid is also a portal to data in a report format concerning future events which facilitates planning and resource allocation. Reports process 190 provides the user with access to such data which enables an accurate assessment to be made of service shop future load by location, vehicle make and calendar date ranges. FIG. 6 provides a flowchart showing the details of this process. At 600, the user links to reports process 190 and then chooses whether to view a report on scheduled reminders or one detailing service center loading at 605. If a reminder report is desired, a beginning and ending date to be covered by the report must be entered at 610. After requesting that the report be created by, for example, clicking on a button appearing on the Appointment Grid, at 615 the central server retrieves data from the reminder date database stored at the remote server for all dealerships served by the system indicating within the indicated date range vehicle by vehicle at which service center location service should take place, the calculated appointment date and the abbreviated VIN associated with each vehicle. This data is used to create a report at 620, and the resulting report is displayed to the user on a display device at 625. If desired, as determined at 630, the report may be exported at 635 as is to another remote display or may be reformatted, as desired, for display elsewhere or storage at a preferred location, such as in database storage device 250. Otherwise, the reports process is exited. If a service shop load report is desired, a beginning and ending date to be covered by the report must be entered by the user at 640. A specific location chosen from among those participating in the use of the system is then selected at 645. After requesting that the report be created by, for example, clicking on a button appearing on the Appointment Grid, at 650 data is retrieved for the selected location from database storage device 250 maintained by remote server 240 representing the shop potential capacity and shop assignment databases for that location and then, at 655 the percent load of that location is calculated by dividing the remaining actual capacity by the potential capacity for that location. With this data, at 660 the system creates a report containing the actual capacity of that location, the potential capacity of that location and the percent load for that location. Finally, at 625, as explained above, the report is displayed to the user on a display device and may then be optionally exported to another location at 635. If a no appointments report is desired, a date range for the report, preferably at least prior to the current date, is entered at 670. A specific location to which the report should relate is chosen from among those participating in the use of the system at 675. At 680, data is retrieved from the no appointments database and the customer history database maintained at remote server 240 for the selected location listing all vehicles at the chosen location which should be serviced within the designated date range but for which no service appointment has been made along with associated customer identifying information. With this data, at 685 the system creates a report listing vehicles and associated customers for which no appointments within the designated date range have been made. This report is displayed to the system user at 625 and may be exported at 635, as discussed above.

FIG. 7 presents a screen shot example of an exemplary Appointment Grid which would be produced by use of the system and method of this invention when accessed through the Internet. Appointment Grid 700 is a spreadsheet comprised of a plurality of vertical and horizontal cells and would be accessible and displayable on any of the display devices connected to the service appointment application of this invention. Buttons 705 identify dealerships using the system and appear in the first row of cells below the Internet browser ribbon at the top of the page. Immediately adjacent are five optional function buttons 710 which may extend into another lower row in the event that there are a large number of participating dealership buttons 705. Button 712 relates to rental vehicles which is not material to the method of this invention. Function buttons 710 correspond to the optional functions selectable at 130. Cells in the next row identify user 715 and sequential dates 720. The next row provides system logout 725, the logo 730 of the dealership which was selected at 300 which can assist the user in quickly recognizing the currently displayed dealership data, and labels for modifiable data presented in columns below each labeled cell. FRH/RO label 735 designates capacity expressed as flat rate hours (FRH) per repair orders (RO). Succeeding cells identify service team or technician names 740, one or more quick lubrication stations 750 and shuttle bus seats 755. The corresponding columns may be color-coded to facilitate data reading by the user. Static row labels appear for Capacity 760 identifying the potential capacity 760 of the dealership, for Situation 765 identifying the actual capacity of the dealership reflecting actual appointments and events and for Control 770 identifying the number of jobs for which customers are waiting on premises and the number of lube oil filter (LOF) jobs for which customers have left their vehicles and are not waiting. Finally, time row labels 775 dividing the day into one-half hour segments or slots are provided. Since the entire day may not fit in the available space, the user can cause the spreadsheet grid to scroll forward and backward to reach the desired time of day for which information is desired. For each time row label 775, data corresponding to assigned work to be performed by the service team or technician names 740, to assigned work for the quick lubrication stations 750 and to the shuttle bus seats 755 is presented for each sequential date 720. As mentioned above, at 120 users can edit information while viewing Appointment Grid 700. The cells that can be edited include those labeled as follows: the number of technicians listed in Capacity 760; the Under 2, Over 2 and PDI/Carryover cells in Situation 765; the LOF/No wait cells in Control 770; and all cells in rows corresponding to time row labels 775. Editable cells are automatically indicated by highlighting such cells when a pointer device such as a mouse is placed within or moved over such a cell. Highlighting may occur by means of using a distinctive color such as green or by any other means which would visually distinguish such cells from surrounding cells. On the other hand, if cells contain inappropriate numbers, such as, for example where overbooking of services beyond those allowed for in the Capacity section of the grid occurs, such cells will also be highlighted, but in this case by using a different distinctive color, such as red or by any other means which would visually distinguish such cells from surrounding cells while maintaining their differentiation from otherwise editable cells. In the event of overbooking, the user is prompted by the appearance of colored numbers, typically red although any color can be selected, to either reduce the booked number of appointments or increase the technicians available to handle such appointments in order to eliminate the inappropriate number error highlighting. Editing is accomplished by clicking on a cell after which a pop-up menu appears allowing the user to increase or decrease the number in the cell as well as to enter notes linked to the cell. Once notes are entered, they will be displayed whenever a mouse or pointing device is moved over the cell to which the notes apply.

FIG. 8 is a flowchart showing how a typical customer visit to a dealership using the method and system of this invention is handled. Use of this system helps to minimize the number of customers who do not appear for scheduled appointments and to establish and track repetitive new appointments with all customers. As a result, revenue of the dealership is increased and resources are efficiently allocated. After a customer is serviced, an invoice is produced at 800 to bill the services and goods provided. The invoice is based on computer entries made by a technician or service consultant in combination with data retrieved from the customer history database. These entries include data fully identifying the vehicle for which the service and/or goods have been provided including specifically its VIN and current mileage, the owner's name, address, telephone number(s) and email contact information to the extent that this information is not available and automatically retrieved from the customer history database. The system user then accesses Appointment Grid 700 and clicks on Select Date button 710 as explained in connection with FIG. 1 to activate select date process 150 which is presented separately in more detail in FIG. 4. After the invoice, any possible customer survey and the process of scheduling next appointments have been explained to the customer at 810, the customer is queried at 815 for general consent to these arrangements. If there is agreement, an appointment card is attached to the invoice at 820 which is then presented to the customer by the cashier along with the invoice at 825. If the customer agrees to the scheduled date at 830, the cashier verifies the appointment in the DMS at 835. Such systems are widely known in the industry and operate in conjunction with appointment systems. A DMS is typically supplied from one of two vendors, Reynolds & Reynolds (RR) and Automatic Data Processing (ADP). If the customer is dissatisfied with the date and wants an alternate date, as determined at 840, a new date is chosen and an appointment card is issued at 845. Data concerning the new date is then transferred at 850 to one of the dealership's Assistance Service Advisors (ASA) and/or to the dealership's Business Development Center (BDC) so that the computer system managing the DMS from which automated appointment reminder notifications by email and telephone are made can be updated. In the event, that the customer does not want a pre-arranged appointment at 840, data for that customer is entered at 855 into a “no appointment” database maintained at remote server 240 by Visible Customer (VC) or another like-functioning application. A report is generated automatically or manually, as preferred, at 860 using report process 180, preferably weekly, based on data contained in the “no appointment” database. This report lists those “no appointment” customers whose vehicles, based on data in the customer history database, should be serviced at a specified future date, preferably within two weeks of the generation date of the report. This “no appointment” report is examined in conjunction with the known appointment schedule for the dealership as stored in the calendar database to determine on which dates more work is needed and/or can be accommodated in the service department in order to balance the dealership's workload. The “no appointment” report can be for one store/location or for multiple stores/locations, as desired. “No appointment” customers are then contacted at 865 in an attempt to schedule an appointment. Such customers are contacted at the beginning of the month or 2 weeks before the due date based on the previously calculated next appointment date. Customer booking occurs on days with the least amount of appointments. Initial contact is attempted by email automatically generated by the VC server. If no response to one or more emails is received after a selected period such as 5 days, the BDC is automatically notified and telephone contact is attempted either by a live person or an automated system, as desired. If an appointment date is successfully established at 870, relevant data is then entered directly into the calendar database at 850. If contact cannot be made with the customer after a selected number of emails and a selected number of calls, as determined at 875, a notation is made in that customers' records in the customer history database and the process is exited. If erroneous email and telephone contact data become apparent during the contact process at 850 or 865, these are corrected, if possible, at 880. In the event that a customer does not appear for a scheduled appointment, as determined at 885, rescheduling is attempted at 890 through the BDC using email and telephone calls, and, if successful, the new appointment is reentered into the VC server so that automated contact can be resumed at 850. When the customer appears for a scheduled appointment, service is provided and the process resumes at 800.

The system and method of this invention provide a variety of useful information and practical benefits to users. By displaying the Appointment Grid, authorized users are able to continuously determine the status of any vehicle during an appointment, while management is provided an overview of the status of location and dealership resources. Furthermore, the provision of an automated “next appointment” procedure increases efficient allocation of labor and parts resources at each participating location and enables establishment of better customer relationships. In addition, a useful and tangible benefit to the dealership results in an increase in both the number of appointments made at every participating location and the number of those appointments which are kept by customers. Consequently, operating revenue is enhanced.

The process steps disclosed herein are not the only way in which the function of this invention can be implemented. Other embodiments and different sequences of steps are possible so long as the overall method and advantages described above are preserved.

What is claimed is:

1. A computer automated, Internet-based method for tracking and increasing the volume of made and kept vehicle service appointments at vehicle service locations by owners of vehicles, the method being used by at least one vehicle dealership having at least one service location at which at least one service team works wherein each location of each dealership is connected through a local area network to every other location of that dealership, to a server and to the Internet and wherein further a remote server is further connected to each local area network over the Internet, said remote server having access to stored databases containing data specific to each location comprising:
accessing the remote server from a particular service location;
retrieving and displaying an appointment grid with data specific to at least one service location;
deciding first whether to edit labels displayed in the appointment grid;
if so, making changes to data appearing in the appointment grid and storing those changes in the appropriate database at the remote server;
otherwise, selecting one function to be performed from the group consisting of configuring the appointment grid, selecting a date, calculating an appointment date, establishing an appointment reminder date and generating reports;
performing the selected function and storing data entered during such performance in the appropriate database at the remote server;
continuously updating and displaying the appointment grid as data from the selected function is entered;
deciding whether to perform a new function;
if so, returning to selecting;
otherwise, exiting the method.

2. The method of claim 1 wherein the databases are a customer history database, a
